(19) United States
(12) Patent Application Publication
(10) Pub. No.: US 2021/0298342 A1
(43) Pub. Date: Sep. 30, 2021

(54) PEAR PROCESSING METHOD AND MULTILANE APPARATUS

(71) Applicant: Biagio CRESCENZO, Salerno (SA) (IT)

(72) Inventor: Biagio CRESCENZO, Salerno (SA) (IT)

(21) Appl. No.: 17/217,258

(22) Filed: Mar. 30, 2021

(30) Foreign Application Priority Data
Mar. 30, 2020 (IT) 102020000006667

(51) Int. Cl. A23N 4/14; A23N 4/02; A23N 4/22; A23L 19/00; B65G 15/12

(52) U.S. Cl. CPC A23N 4/14; A23N 4/02; A23N 4/22; B65G 2201/0211; B65G 15/12; A23V 2002/00; A23L 19/03

(57) ABSTRACT

A method for processing pears advancing on housing and centering cups (9) of a multilane belt (7) with its calycine end facing upwards, in order to be cored, pitted and halved the method provides, in a first step, locking each pear against rotation inside its housing and centering cup (9), to measure the distance of the calycine end, and to communicate said distance to a control unit (14) that determines the height position of the endocarp of that pear, and, in a second step, to lower simultaneously, by the control unit (14), a coring rod (24) and a pitting knife (26) from a rest position to the height of the endocarp of the underlying pear, as determined by the control unit (14). A multilane apparatus for processing pears is also disclosed.

### TECHNICAL FIELD

The present invention relates to a pear processing method and multilane apparatus.

### BACKGROUND ART

CA 767953 A and U.S. Pat. No. 3,246,676 of the same family disclose a pear processing apparatus having means for controlling the depth of the endocarp in a pear, means for supporting a knife for moving the knife in and out of a pear to be cored, means for adjusting the displacement of the knife according to the size of the fruit to be cored. The means for controlling the depth of the endocarp are of the mechanical type, which require the control means to contact the pear to be cored. Since the fruits have different sizes, their endocarp, or cell that encloses the seeds, also has depths from the surface of the fruit that vary according to the size of the same. Also disclosed is depth control means adjacent to the knife and engageable with the surface of the fruit when the knife is in the fruit and means sensitive to the movement of the knife towards the fruit to automatically adjust the depth control means during the movement of the knife into a coring position so as to vary the distance of the depth control means from the end of the knife according to the size of the fruit to be cored in order to control the depth of entry of the knife into the fruit. The depth control means is a mechanical means that moves the knife into the coring position and operates by resting on the fruit to be cored.

WO/2018/234908 describes a method of recognizing the orientation of a fruit having a central axis of symmetry passing through the concave parts of the fruit, i.e. its peduncle cavity and its calycine cavity. The fruit advances on a multilane belt, formed by mesh dements and fruit holding flights having a plurality of recesses. Each recess is equipped with a central opening showing the fruit contained within it. The method comprises an individual measurement step of each fruit to be treated advancing on the fruit bearing multilane belt, by means of a distance meter, preferably a laser meter to evaluate whether the distance measured in a measurement step of each individual fruit is that of a concave part of the fruit or that of a convex part of the same. The purpose of the invention described in the aforementioned international patent application is to establish whether the fruit is correctly oriented with its central axis of symmetry in a vertical position.

U.S. Pat. No. 3,373,786 discloses a machine for processing apples or the like having:
a combination of means defining a pocket with an aperture therein, and supporting an apple with a removed stem;
a vertically movable carrier disposed above said pocket;
a coring unit carried by said carrier;
a continuously rotating cutter on said coring unit, rotating about an axis concentric with the axis of said aperture, said cutter having a cutting edge movable in a cylindrical path;
means for swinging said cutter from a retracted position wherein said cutting edge moves in a cylindrical path, having a diameter slightly less than that of said cylindrical stem cavity to an extended position, wherein said cutting edge moves in a cylindrical path having a diameter in excess of the diameter of the stem cavity to sever the seed cell from the apple.

Each revolving knife of the coring unit is equipped with its own actuator to determine its rotation movement.

U.S. Pat. No. 3,199,558 discloses a fruit stemming, coring and splitting machine. The machine includes a conveyor multilane belt equipped with fruit holding flights. Each flight includes a row of fruit support and orientation cups. Each cup has a pair of fixed front and rear walls and a pair of movable jaw walls. The movable jaw walls are mounted opposite each other for a unitary rotation movement about a rotation pin to lock or release a fruit. Mounted on the carrier support is a movable pneumatic piston in engagement with one of the front and rear walls to move the front and rear walls into the fruit locking position. In fact, the jaw walls are engaged with each other with toothed sector portions provided in front on one side and in the other towards the inside with respect to the rotation pins. The movable jaw walls are not kept blocked by a mechanism that guarantees during the coring and pitting and halving operations the effective locking of the fruit in the support and orientation cup.

### SUMMARY OF THE INVENTION

The present invention aims to obviate the aforementioned drawbacks, encountered in the known art.

An object of the present invention is to determine the position of the endocarp, or seed cell, of a pear for the purpose of subsequent coring and pitting without using complex and expensive mechanical means.

Another purpose of the invention is to reduce the component parts in a cutting station.

Still another object of the present invention is to improve the belt conveyor with particular regard to the support and orientation cups for pears whose jaw walls are closed against each other during the coring, pitting and splitting operation to obtain an effective locking of the fruit in the support and orientation cup.

A further object of the present invention is to limit as much as possible the waste of raw material in fruit processing, in particular during the removal of the core.

Yet another object of the invention is to provide apparatus that is modular in order to change the number of its processing lanes according to needs. In a first aspect of the invention, there is provided a method for processing pears having an endocarp located at a distance from the calycine end depending on the pear longitudinal size, the pears advancing in an apparatus controlled by a control unit on a multilane belt comprising mesh elements and fruit holding flights having a plurality of housing and centering cups in each of which a pear is positioned with its calycine end facing upwards, in order to be cored, pitted and halved, the method comprising:
in a first step of advancing the multilane belt, locking each pear against rotation inside its housing and centering cup, and measuring the distance of the calycine end to know the pear longitudinal size; and
in a second step of advancing the multilane belt, simultaneously lowering, by the control unit, a coring rod and a pitting knife from a rest position to the height of the endocarp of the underlying pear, as determined by the control unit, each pitting knife being rotated simultaneously with the other pitting knives at different heights according to the longitudinal size of the pear to be pitted,
   method wherein the distance of the calycine end of each pear is measured without contact, and is communicated to the control unit which determines the height position of the endocarp of that pear.

In a second aspect of the invention there is provided a multilane apparatus for processing pears that carries out the above defined method.

It is known that each pear has an endocarp, or seed cell, located at a distance from its calycine end depending on the longitudinal dimension of the pear, that is, on its size. According to the invention, the longitudinal measurement of a pear positioned in a centering and supporting cup of the fruit holding flight with its calycine end facing upwards by means of a contactless distance measurer determines the height position of the endocarp: once the cutting depth has been established, the pear can be cored, pitted and halved, with minimal waste of raw material. Preferably, the longitudinal measurement is performed by means of laser distance sensors which are not invasive towards the pear to be measured and do not need additional transducers to communicate the measurement of the calycine end, and therefore of the endocarp, to the control unit which controls the lowering of the pitting knife of the relative substation.

Unlike the known art, the depth control means are not mechanical means which move the knife into the pitting position and operate by resting on the fruit to be cored.

### BRIEF DESCRIPTION OF THE DRAWINGS

Further features and advantages of the present invention will become most clear from the indicative, and therefore non-limiting, description of the multi-lane apparatus for processing pears, as illustrated in the accompanying drawings in which:

FIG. 1 is a cross-section view showing a cutting station of the apparatus from the side of the pear advancement;

FIG. 2 is a cross-section view showing the cutting station in FIG. 1 from the rear, seen from the opposite side;

FIG. 3 is a perspective view of the cutting station in FIG. 2;

FIG. 4 is a cross-section view taken from the front of a metering substation in the cutting station in FIG. 1 from the side of the pear feeding;

FIG. 5 is a side view of the metering substation in FIG. 4;

FIG. 6 is a partial perspective view from the front and from the top of a coring and pitting substation of the cutting station, limited to a single pitting knife;

FIG. 7 is an enlarged detail in FIG. 6;

FIG. 8 is a cross-section view taken according to a plane a in FIG. 6 of a coring and pitting device seen by the arrows A-A in the operative position;

FIG. 9 is a cross-section view taken along the lines B-B in FIG. 8;

FIG. 10 is an enlarged detail in FIG. 9;

FIG. 11 is a cross-section view taken according to the plane a in FIG. 6 of the coring and pitting device seen by the arrows A-A in the rest position;

FIG. 12 is a cross-section view taken along the lines C-C in FIG. 11;

FIG. 13 is a cross-section view of the halving substation of the cutting station in FIGS. 1 to 3;

FIG. 14 is a side view of the halving substation of the cutting station in FIG. 13;

FIG. 15 is a perspective view of a cup of the pear processing apparatus of the present invention in an open position, and on an enlarged scale;

FIG. 16 is a side view of the cup in FIG. 15;

FIG. 17 is a top plan view of the cup in FIG. 15;

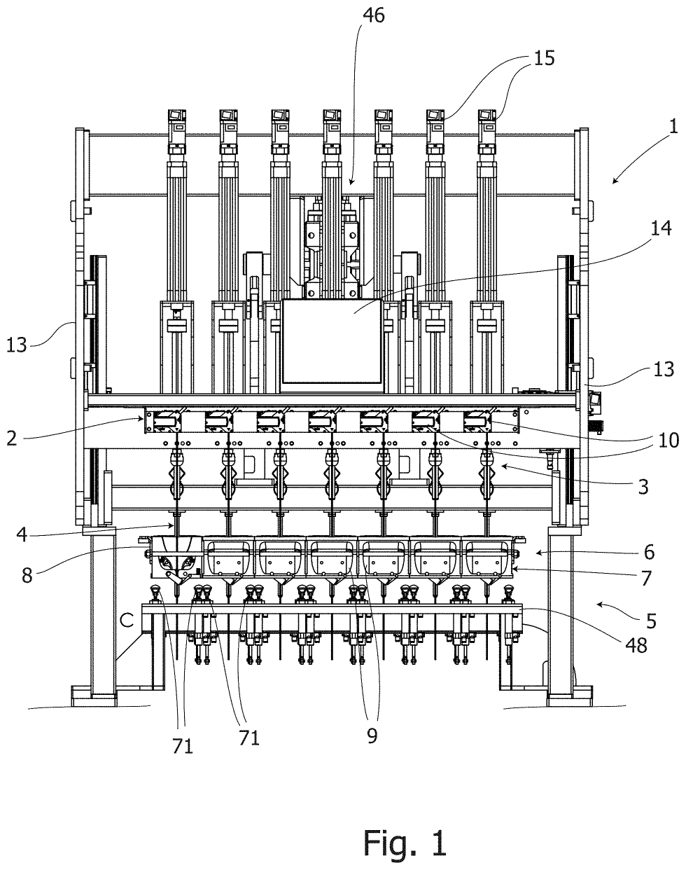

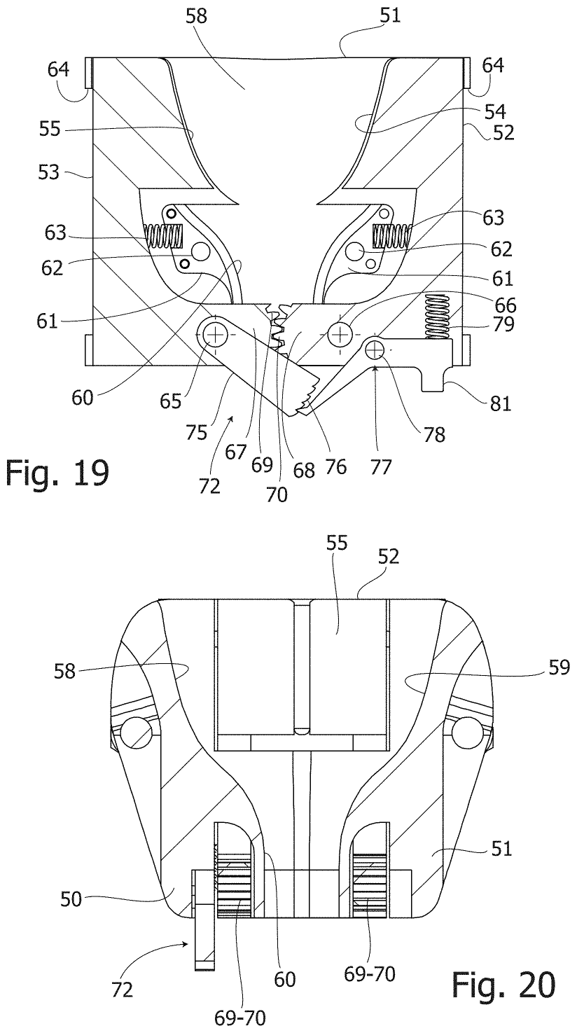

FIG. 1.8 is a front view showing the internal cavities in hatching of the cup in FIG. 15;

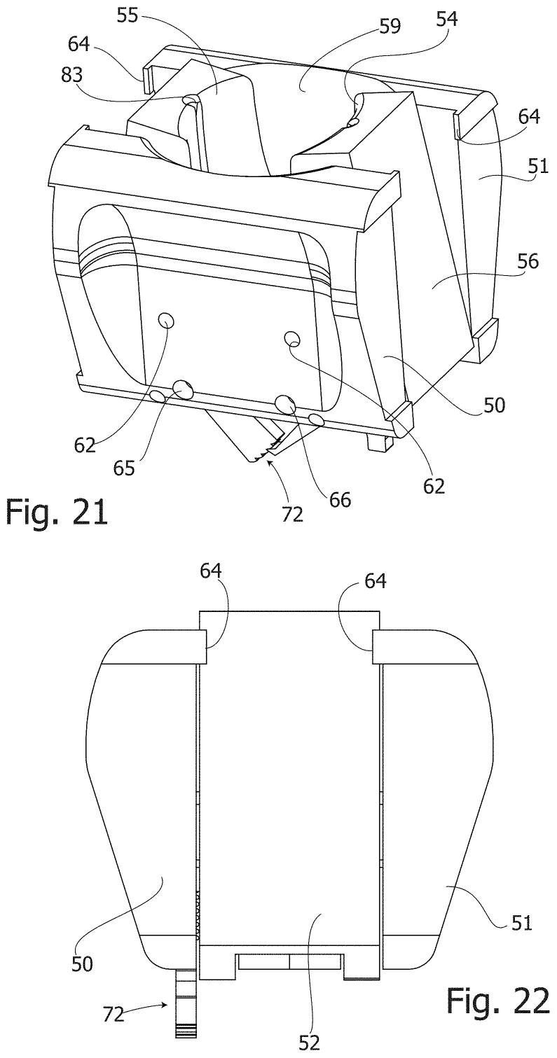

FIG. 19 is an antero-posterior cross-section view along the lines D-D of the cup in FIG. 16;

FIG. 20 is a transverse cross-section view obtained along the lines E-E in FIG. 18;

FIG. 21 is a perspective view of a cup of the pear processing apparatus of the present invention in a clamping position of a pear, and on an enlarged scale;

FIG. 22 is a side view of a cup in FIG. 21;

FIG. 23 is a top plan view of the cup in FIG. 21; and

FIG. 24 is an antero-posterior cross-section view of the cup in FIG. 21.

### DESCRIPTION OF AN EMBODIMENT OF THE INVENTION

Reference is made initially to FIGS. 1 to 3, which show in a cross-section view a cutting station of the apparatus seen respectively from the forward side of the pears, and from the rear side, also in perspective. Other parts of the apparatus are described in PCT/IB2020/057305 entitled “Pear feeding method and apparatus for multi-lane processing” filed on 2 Aug. 2020. It describes in particular the supply of pears to a feeder with translating shelves, the singularized passage of the pears in a plurality of chutes, the advancement of the pears with their peduncle downwards in a plurality of advancement channels, the holding of each single pear coming out of its feed channel in a respective receiving jaw, and the simultaneous cutting of the pear stems by means of a cutting device, Once the stems have been cut, the pears are subjected to coring and pitting and then halved according to the method of the present invention.

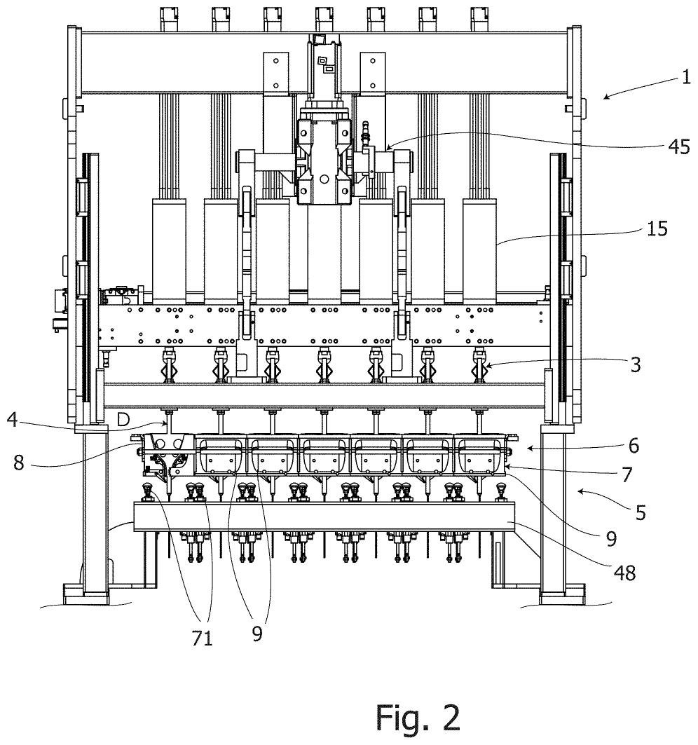

With reference to FIGS. 1 to 3, the cutting station generally indicated as 1, comprises a measuring substation 2, according to the present invention, a coring and pitting substation 3 and a halving substation 4, The cutting station 1 is mounted on a frame 5. A conveyor 6 has a multilane belt 7 movable with a direction of advancement from a pear feeding station, not shown, towards the cutting station 1. The multilane belt 7 is formed by mesh elements and fruit holding flights 8 including a plurality of housing and centering cups 9 suitable for receiving respective pears (not shown) with the calycine end facing upwards. The housing and centering cups 9 will be described in detail below. A housing and centering cup 9, the first on the left in FIGS. 1 and 2, is shown in a cross-section view.

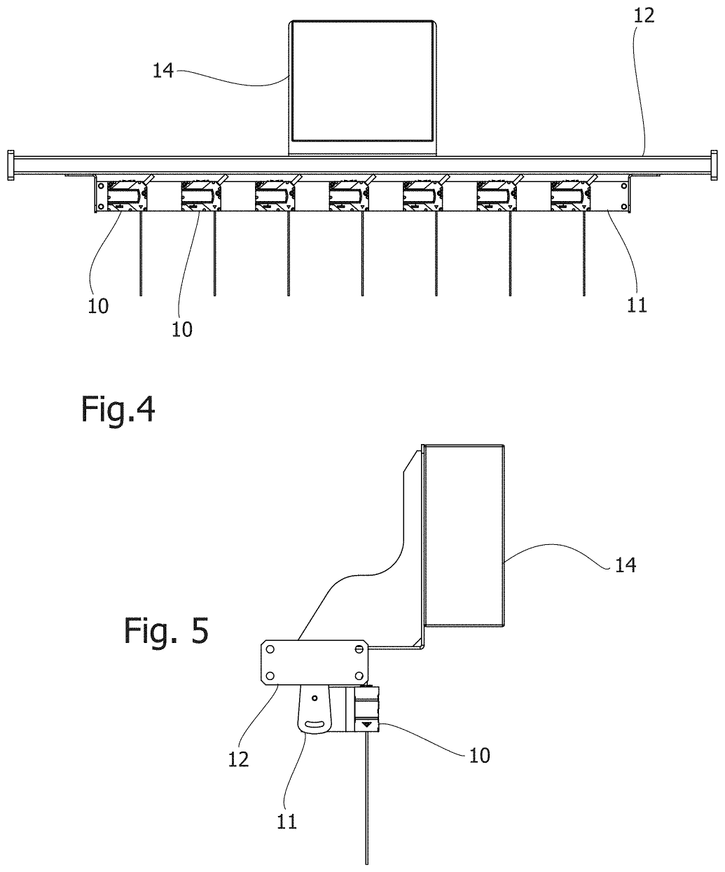

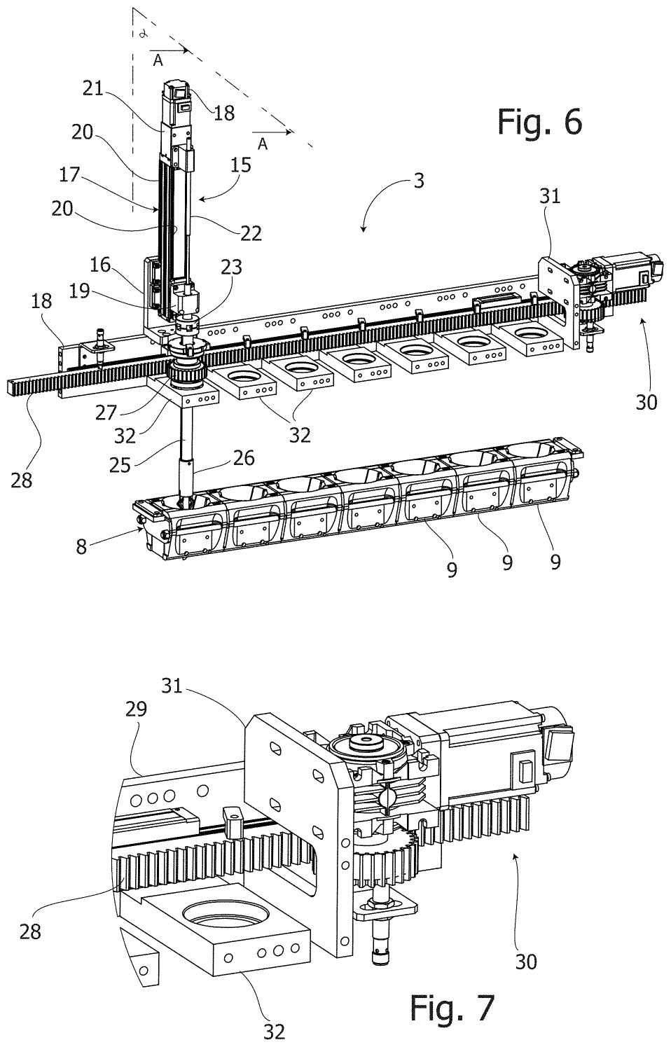

In FIGS. 4 and 5, which are a cross-section view taken from the forward side of the pears and a side view thereof, respectively, the measuring substation 2 is shown separated from the cutting station 1.

The measuring substation 2 includes a plurality of contactless distance meters 10. The contactless distance meters 10 are mounted by means of an adjustable support 11 to a horizontal support rod 12 fixed to the uprights 13 of the frame 5. The contactless distance meters 10 are equal in number to the rows of housing and centering cups 9 in each mesh element and fruit holding flight 8 of the multilane belt 7. The rows of housing and centering cups 9 are positioned below in turn in the advancement of the multilane belt 7, stopping during the measurement. The contactless distance meters 10 are preferably laser measurement sensors. As an example, the al-LD model from Omron Corporation of Kyoto (Japan) can be taken. The meters 10 are electrically connected to a control unit 14.

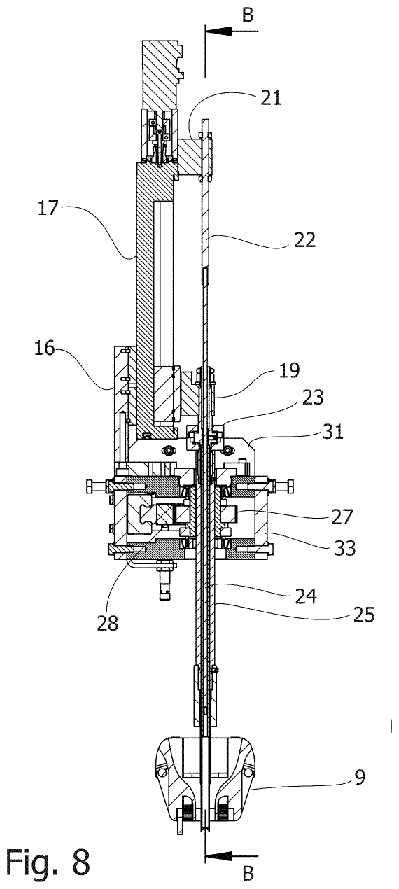

The contactless distance meters 10 are oriented so as to read the center of each housing and centering cup 9. If a pear is positioned in the latter, the laser beam reaches the calycine end of the pear and communicates the distance read to the control unit 14. Knowing the calycine end of the pear allows to know the longitudinal dimension of the pear to be treated, since the distance of the contactless distance meters 10 from the multilane belt 7 of the conveyor 6, where the pear is positioned, is known. The position of the endocarp, or seed cell, can be determined in this way in each pear, since the endocarp in a pear is known to be at a constant distance from the calycine end, with the same longitudinal dimension of the pear. The endocarp position information is transmitted from the control unit to the coring and pitting substation 3 shown for representative clarity with only one coring and pitting device 15 in FIG. 6 which is a partial perspective view from the front and top of a coring and pitting substation of the cutting station.

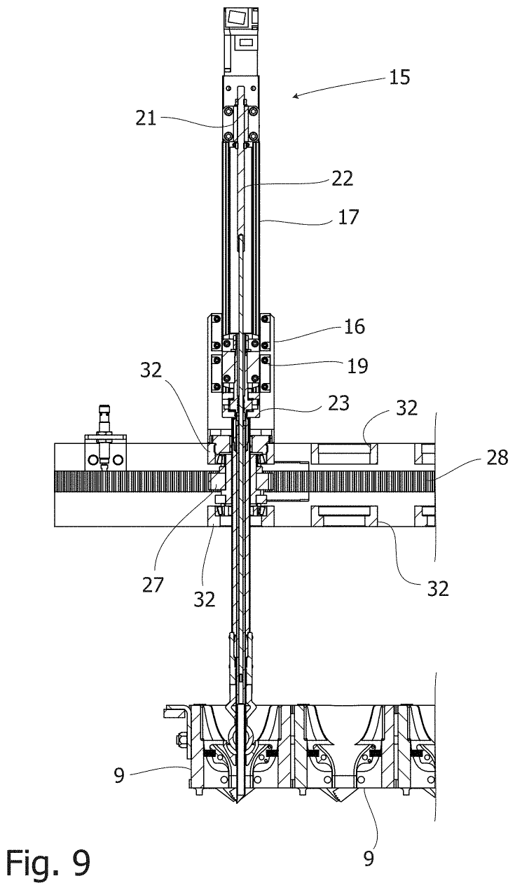

Each coring and destoning device 15, unlike as shown schematically in FIG. 1, is mounted on an angular bracket 16 to the frame 5 of the apparatus. The device 15, as will be called for simplicity in the following, comprises an actuator 17 having a brushless motor 18 adapted to move a slide 19 on a prismatic guide 20. The brushless motor 18 is mounted at the free end of the prismatic guide 20. In proximity to the brushless motor 18, a sleeve 21 mounted about the prismatic guide 20 rigidly supports a guide rod 22. Slidably mounted on the guide rod 22 is a slide 19, to which a coring rod 24 and, coaxially thereto, a lobed shaft 25 carrying at its end a pitting knife 26 are fixed by means of a bush 23. It should be understood that, thanks to the arrangement described above, the coring rod 24 and the pitting knife 26 move together vertically. The lobed shaft 25 is coupled to a pinion bushing unit 27 in engagement with a rack 28. The rack 28 is mounted slidingly on a crosspiece 29 of the frame 5 and is moved at one end by a gearmotor 30 shown in enlarged scale in FIG. 7 externally to a portion 31 of the frame. The pinion bushing unit 27 is supported by a perforated base 32 fixed orthogonally to the crosspiece 29. Even if not shown in FIG. 6 in the other perforated bases 32 there are as many devices 15, in the same number of housing and centering cups 9 present in each mesh element and fruit holding flight 8 of the multilane belt 7 of the conveyor 6. Thanks to this arrangement, the lobed shaft 25 can rotate around the coring rod 24 to carry out pitting. According to the present invention, each pitting knife 26 is lowered together with its coring rod 24 in the height position of the pear endocarp. This displacement is controlled by the control unit 14 thanks to the measurement carried out by the respective contactless distance meters 10 in the measuring substation 2 on the pear located in the corresponding housing and centering cup 9. If the housing and centering cup 9 is empty, the contactless distance meters 10 communicates this information to the control unit 14 which will not give any displacement order to the brushless motor 18 of the coring and pitting device 15.

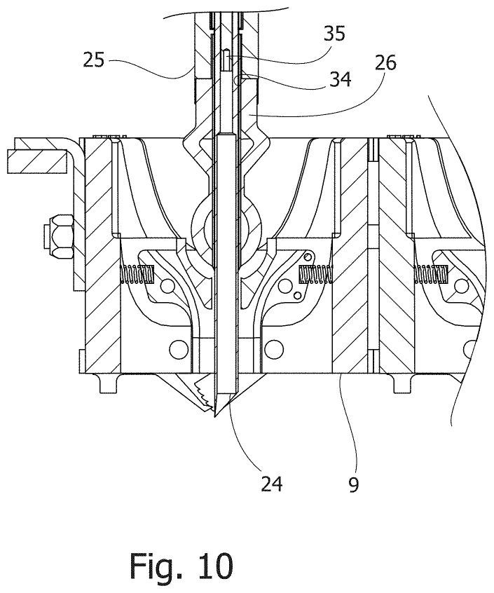

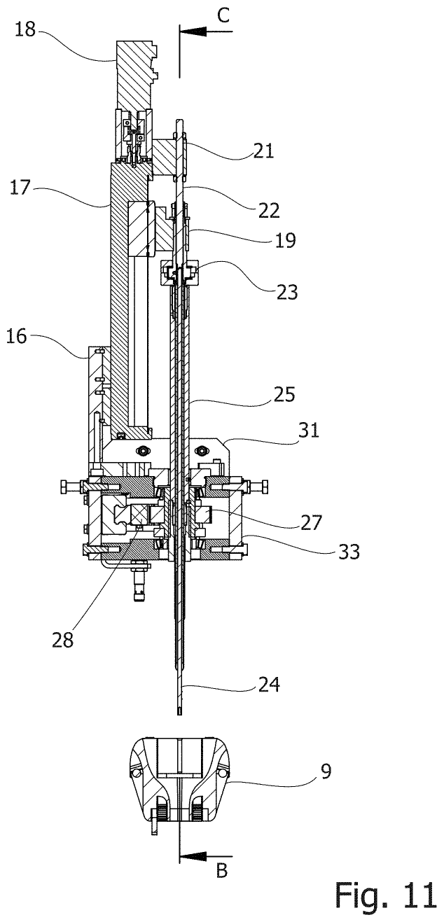

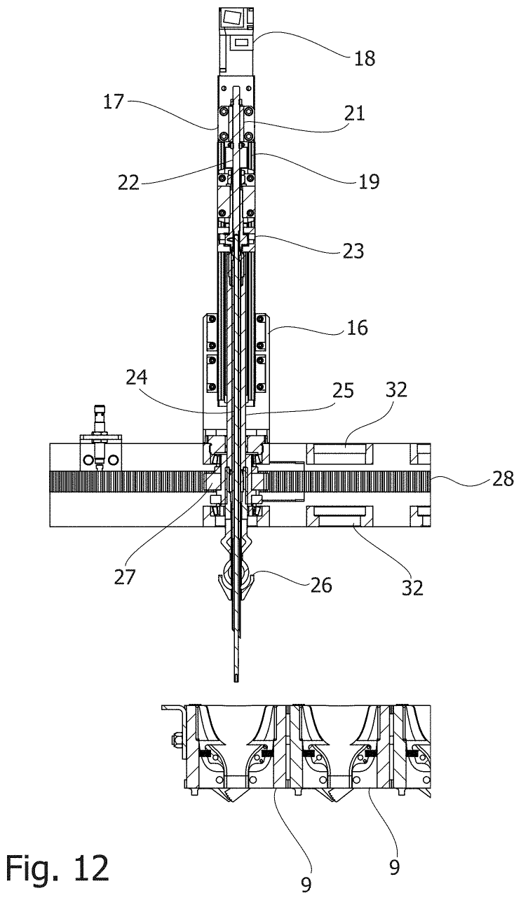

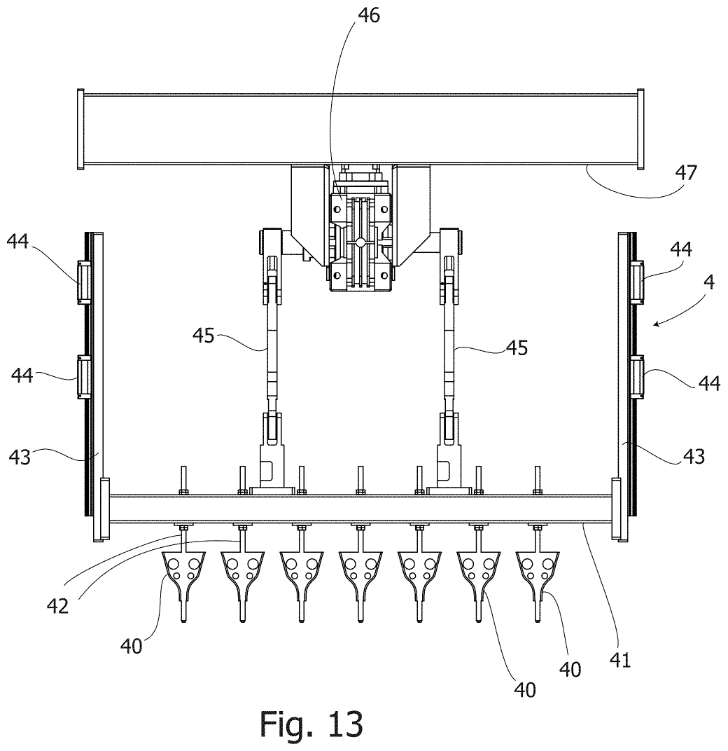

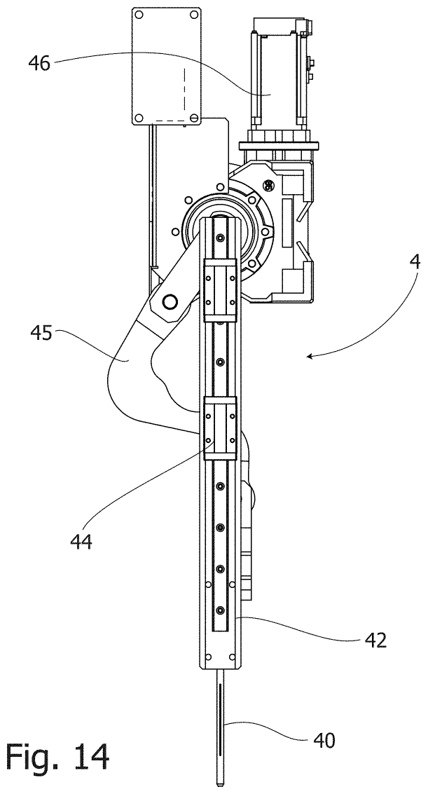

Reference is made now to FIGS. 8 and 11 which are a cross-section view obtained according to a plane a in FIG. 6 of the coring and pitting device seen by the arrows A-A in the operating position and in the rest position, and to FIGS. 9 and 12 which are a cross-section view obtained along the lines B-B in FIG. 8 and the lines C-C in FIG. 11, and also to FIG. 10 which is an enlarged detail in FIG. 9. In the cross-sections view of FIGS. 8 and 9 in which the pinion bushing unit 27 is closed in a housing 33, the engagement between the rack 28 and the pinion is shown. It is understood that the bushing coaxial to the pinion is mounted on axial bearings on the bases 32 for supporting the device. It can be noted that the bases 32 are provided on both sides with respect to the rack 28. The rotation of the lobed shaft 25 is performed simultaneously by the single gearmotor 30, whether the coring and pitting device 15 has lowered simultaneously with its brushless motor 18 the coring rod 24 together with the pitting knife 26, or it has not done so for lack of a pear in the relative centering and support cup 9.

FIG. 10 shows an enlargement of FIG. 9 where a housing and centering cup 9 is visible in section with the coring rod 24 inside and the pitting knife 26 coaxially to it. The housing and centering cup 9 will be described in greater detail later. It should be noted that the coring rod 24 slides inside a coaxial duct 34 formed by the lobed shaft 25. Near the lower end of the lobed shaft 25 there is a fixed spindle 35 inside the coaxial duct 34. The fixed spindle is not vertically movable.

The fixed spindle 35 serves to prevent the lifting of core residues inside the coaxial duct 34 by the coring rod 24 when the coring rod 24 and the pitting knife 26 are simultaneously moved upwards in the rest position.

In FIGS. 11 and 12, as mentioned above, the coring and pitting device 15 is shown in section with the set of coring rod 24 and lobed shaft 25 of the pitting knife 26 moved to the rest position thanks to the lifting of the slide 19 by the brushless motor 18.

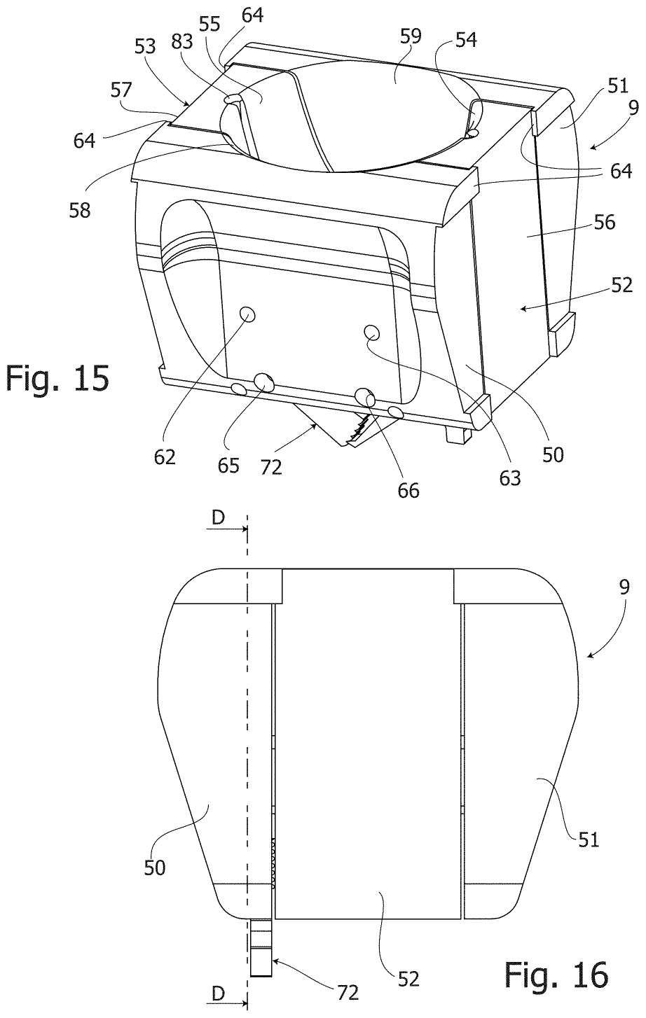

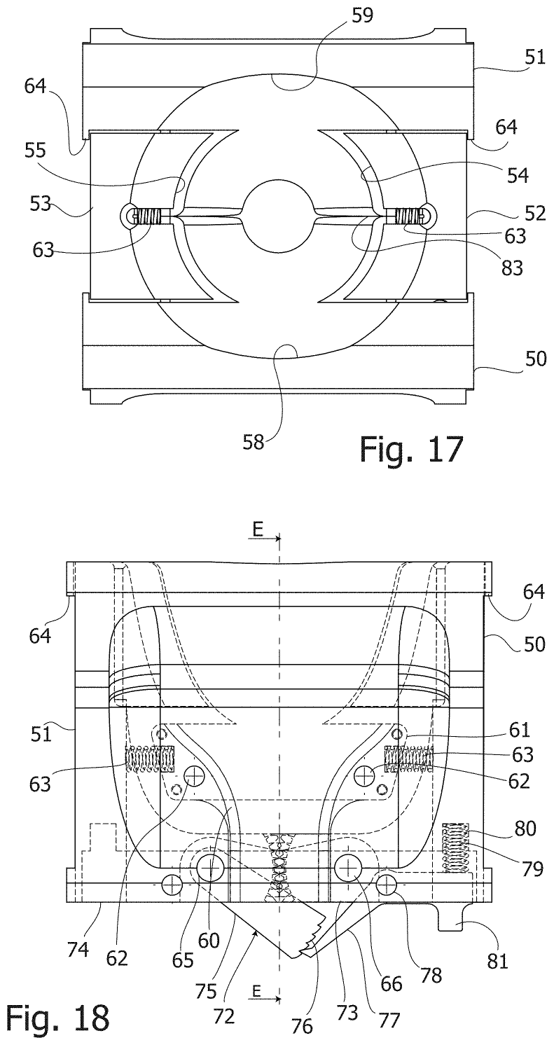

See now FIGS. 13 and 14 which are a cross-section view of the halving substation of the cutting station of FIGS. 1 to 3 and a side view of the halving substation of the cutting station in FIG. 13. In the halving substation 4 halving blades generally indicated as 40 are mounted on a horizontal rod 41 by means of relative stems 42. The halving blades 40 have a front profile which, as will be seen below, is complementary to the cross-sectional profile of a cavity for the pear obtained in the housing and centering cup 9. The horizontal rod 41 is vertically movable on lateral guides 43 integral with the frame 5 of the apparatus by sliding with guides and recirculating ball slides generically designated as 44. The horizontal rod 41 is connected by means of a system of levers 45 to a second gearmotor 46, supported by a crosspiece 47 of the frame 5.

It must be understood that, in order to satisfactorily carry out the coring, pitting and halving operations, each pear must be adequately held inside its housing and centering cup 9.

Reference is made to FIGS. 15 to 20, which are a perspective view, a side view, a top plan view, a front view showing the internal cavities in hatching, an enlargement of a detail in FIG. 12 or an antero-posterior cross-section. rear, and an enlargement of a detail of FIG. 11 or a cross-section view, respectively, of a cup of the pear processing apparatus of the present invention in the open position. Reference is also made to FIGS. 21 to 24, which are a perspective view, a side view, a top plan view and a transversal antero-posterior cross-section view, respectively, of a cup of the pear processing apparatus of the present invention in a pear clamping position.

As previously said, the multilane belt 7 of the conveyor 6 is equipped with mesh elements and fruit holding flight 8. Each mesh element and fruit holding flight 8 includes a row of housing and centering cups 9. Each housing and centering cup 9 has a pair of fixed side walls 50, 51 arranged transversely to the direction of advance of the multilane belt 7 and a pair of jaw walls 52, 53 orthogonal to the fixed side walls 50, 51. The fixed side walls 50, 51 are connected together by means of pins indicated generically with 62. The jaw walls 52, 53 are substantially in the shape of a vane with concave facing surfaces 54, 55 to adapt to the profile of the pear, and opposite surfaces 56, 57. The jaw walls 52, 53 are preferably made of plastic, to be light and not to cause damage to the fruit that is held by them. The fixed side walls 50, 51 can also be conveniently made of plastic material. Like the concave facing surfaces 54, 55, the internal surfaces 58, 59 of the fixed side walls 50, 51, intended to come into contact with the pears, are also concave. With reference to FIG. 16, in the fixed front wall 50 of the housing and centering cup 9 there is shown, projecting downwards, a ratchet mechanism 72 which will be explained below.

As shown in the front view of FIG. 18 and in the cross-section view obtained in the direction transverse to the advancement of the multilane belt, shown in the open position in FIG. 19 and in the clamping position in FIG. 24, the pins 62 which connect together the front and rear fixed walls 50, 51 of the housing and centering cup 9 serve to lock a funnel 60 between the same fixed walls 50, 51. The funnel 60 extends laterally in ribbed parts 61. As shown in FIG. 18, the profile of the funnel 60 is mated to the profile of a pear. In the ribbed parts 61 there is a pair of opposite seats for helical springs indicated generically with 63, The other end of the helical springs 63 is abutting against the respective jaw wall 52, 53.

On the ends of the front and rear fixed walls 50, 51 there are protrusions, indicated generically with 64, which act as an abutment for the jaw walls 52, 53.

FIG. 19 shows a cross-section view taken along the line D-D in FIG. 16. The jaw walls 52, 53 are hinged about a respective rotation pin 65, 66 passing through the front and rear fixed walls 50, 51. Each jaw wall 52, 53 has the gripping surface 54, 55 and a pair of projections 67, 68 equipped with toothed sectors 69, 70 mutually engaged, so that the two jaw walls 52, 53 are able to rotate in synchronism the one with respect to the other between an open position in the advancement towards the cutting station, and a clamping position in the cutting station, obtained as described below. In the cross-section view of FIG. 20, obtained with a cross-section obtained along the lines E-E in FIG. 18, the pairs of toothed sectors 69, 70, mutually engaged, of the jaw walls 52, 53 are shown.

The jaw walls 52, 53 are normally in the open position in which they abut against protrusions 64 of the fixed walls 50, 51. To pass into the closed or clamping position shown in FIGS. 21 to 24, the jaw walls 52, 53 must be rotated towards each other about rotation pins 65, 66, which are mounted parallel to pins 62, 62 on the front and rear fixed walls 50, 51. To achieve this commanded rotation of the jaw walls 52, 53, on a plane 48 connected to the frame 5 of the apparatus, under the multilane belt 7 of the conveyor 6 there is mounted, for each housing and centering cup 9, a pair of pneumatic pistons indicated generically with 71 in FIGS. 1 and 2. The pneumatic pistons 71 push on both jaw walls 52, 53 in their bases 73, 74 in an off-center position with respect to the rotation pins 65, 66. According to the present invention, this clamping position is maintained thanks to the ratchet mechanism 72, more clearly shown in FIGS. 18, 19 and 24.

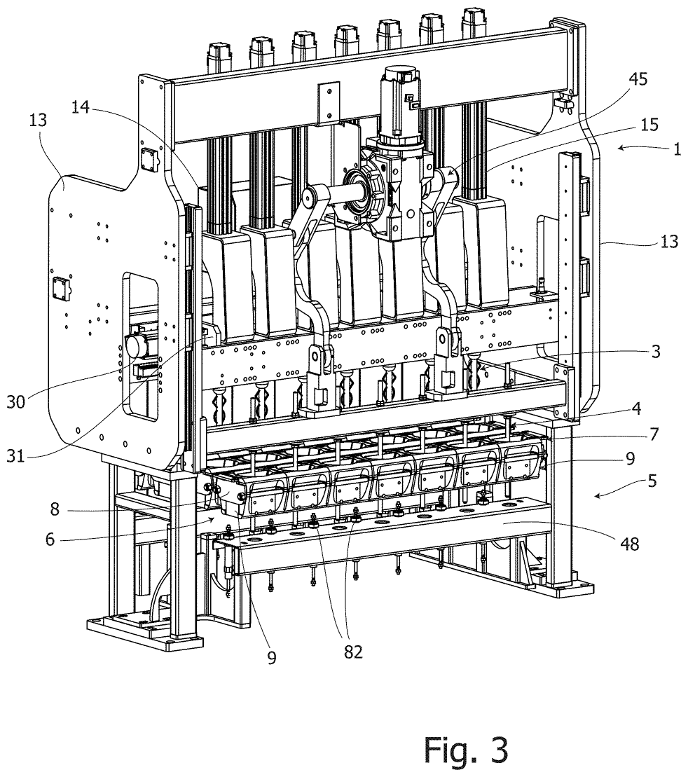

In proximity to the base 74 of the jaw wall 53, in correspondence with the rotation pin 65, an arm 75 is integral with the jaw 53 having a succession of teeth 76 at its free end. A hook 77 is hinged on the respective front wall 50 of the housing and centering cup 9 about a pivot 78, The hook 77 is spring loaded by means of a spring 79 housed in a seat 80 of the front wall 50; the hook 77 engages with the teeth 76 of the arm 75 of the jaw wall 53, so as to lock the jaw wall 53, with which the arm 75 is integral, in the open position as shown in FIGS. 18 and 19, or in closed position as shown in FIG. 24. It should be understood that the locking of the jaw wall 53 consequently entails the locking in the same position of the facing jaw 52 thanks to the pairs of toothed sectors 69, 70, mutually engaged, of the jaw walls 52, 53. The transition from the closed or clamping position to the open position is obtained by causing the rotation of the hook thanks to the upward thrust exerted on a protrusion 81 of the hook against the spring 79. This operation is performed by a pneumatic piston 82, also mounted on the plane 48 of the frame 5 of the apparatus, underneath the multilane belt 7 in correspondence with the halving substation 4, as shown in FIG. 3.

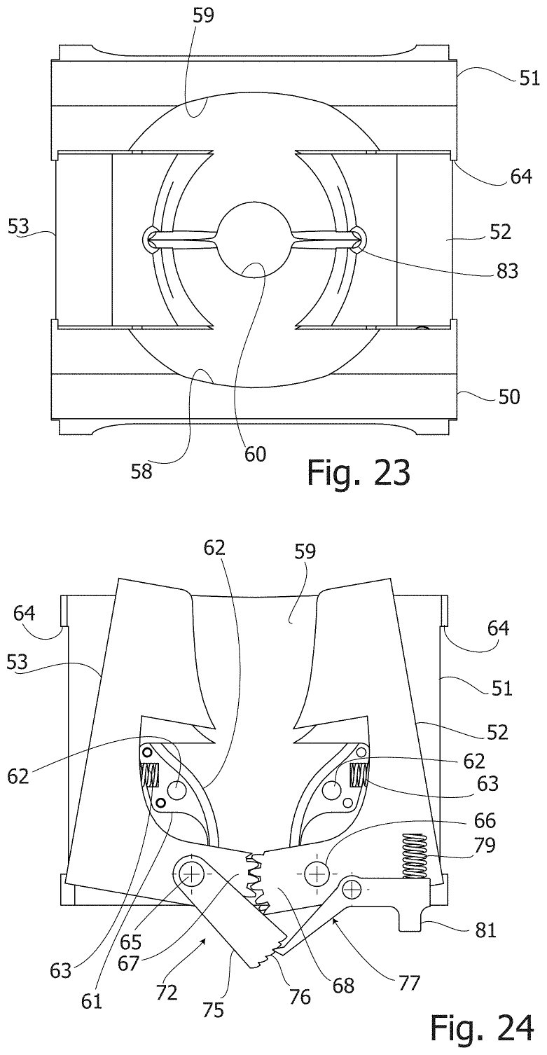

With reference to FIGS. 15, 17 for the open position of the housing and centering cup 9 and to FIGS. 21 and 23 for the clamping position of the same, it should be noted that on the concave surface 54, 55 of the jaw walls 52, 53 a groove 83 is made to receive the halving blade 40 in the halving substation 4. The groove 83 is shaped like the peripheral profile of the halving blade 40. Below in the concave surface of the walls 54, 55, as mentioned above, there is a seat where a helical spring 63, 63 abuts. The helical spring 63, 63, in its other end, abuts against the ribbed part 61 of the funnel 60, In this way, each jaw wall 52, 53 is loaded towards the open position even when it is in the clamping position locked by the ratchet mechanism 72 in the cutting station 1.

It should be understood that the ratchet mechanism 72 allows for the improvement of the prior art multilane belt conveyor because the housing and centering cups for the pears have the jaw walls actually closed against each other during the coring, pitting and halving operations to keep the pears effectively locked in the housing and centering cup. In this way, the coring stem will act exactly in correspondence with the stem—calyx axis of the pear, and the pitting knife will not cause the pear to rotate with consequent damage to the pitting.

The apparatus described above allows the method for processing pears according to the present invention to be carried out. Pears generally have a central axis of symmetry passing through the stem end and the calycine end. They have an endocarp located at a constant distance from the calycine end with the same longitudinal dimension of the pear. The pears, fed into a feeding station, advance into the apparatus controlled by the control unit 14 on the multilane belt 7 of the conveyor 6. The multilane belt 7 is formed by mesh elements and fruit holding flights 8, having the plurality of housing and centering cups 9 in each of which a pear is positioned with its calycine end facing upwards. On reaching the cutting station 1, the pear in a first advance step of the multilane belt 7 is blocked against rotation inside its housing and centering cup 9 by means of the jaw walls 52, 53 kept in the clamping position by the ratchet mechanism 72. The pear, being placed under the contactless distance meter 10, is measured by verifying the distance of the calycine end of the pear from the contactless distance meters 10, The longitudinal dimension of the pear is thus determined and, therefore, this information is transmitted to the control unit 14 which establishes the height position of the endocarp of the pear which is at that moment in the housing and centering cup 9.

In a second step of advancing the multilane belt, the pear is locked against rotation inside its housing and centering cup 9 by means of the jaw walls 52, 53, maintained in the clamping position by means of the ratchet mechanism 72, under the coring rod 24 and the pitting knife 26 in the rest position. The control unit 14 simultaneously lowers the coring stem 24 and the pitting knife 26 until reaching the height position of the endocarp of the underlying pear as calculated in the first advancement step of the multilane belt 7. The coring rod 24 crosses the pear from the calycine end to the stem end, at the same time the pitting knife 26 moves to the height of the endocarp and is rotated simultaneously with the other pitting knives. Then, the coring rod 24 and the pitting knife 26 are raised. Any core residues are removed in a return stroke to the rest position.

In a third advancement step of the multilane belt 7, the housing and centering cups 9 of a fruit holding flight are in the halving substation. Here, the halving blades are lowered and the pears are halved. The pneumatic pistons 82, which are located in the halving substation, act on the protrusion 81 of the hooks 77, opening the ratchet. The jaw walls 52, 53 of the housing and centering cups 9 pass into the open position and the pears are overturned in the end rotation of the multilane belt 7 into a collecting vessel.

What is claimed is:

1. A method for processing pears having an endocarp located at a distance from the calycine end depending on the pear longitudinal size, the pears being positioned with their calycine end facing upwards, in order to be cored, pitted and halved on a multilane belt advancing step by step and comprising mesh elements and fruit holding flights, having a plurality of pear housing and centering cups in an apparatus controlled by a control unit, the method comprising:
a first step of advancing the multilane belt, in which each pear is blocked against rotation inside its housing and centering cup, and the distance of the calycine end is contactless measured to know the pear longitudinal size, and
a second step of advancing the multilane belt, in which a coring rod and a pitting knife are simultaneously lowered, by the control unit, from a rest position to the height of the endocarp of an underlying pear, as determined by the control unit, and each pitting knife is rotated simultaneously with the other pitting knives at different heights according to the longitudinal size of the pear to be pitted.

2. A multilane apparatus for processing pears, comprising on a frame:
a control unit,
a cutting station including:
a coring and pitting substation, that holds coring rods and pitting knives, and
a halving substation, that carries halving blades, and
a conveyor, having:
a multilane belt movable with advancement direction towards the cutting station and being formed by mesh elements and fruit holding flights;
a plurality of housing and centering cups in each fruit holding flight suitable for receiving respective pears with calycine end facing upwards;
a front wall and a rear wall that are fixed and face each other in each housing and centering cup transversely to the advancement direction of the multilane belt; and
a pair of jaw walls hinged around a respective rotation pin, held by the front wall and rear wall, each jaw wall having a gripping surface and a pair of projections equipped with toothed sectors mutually engaged with the toothed sectors of the facing jaw wall, so that the two jaw walls, equipped with bases, are able to rotate in synchronism with each other between an open position in a forward movement towards the cutting station and a clamping position in the cutting station;
wherein located before the coring and pitting substation is a measuring substation, including a plurality of contactless distance meters overlying the plurality of housing and centering cups which are positioned in turn below in the advancement of the multilane belt, each contactless distance meter being suitable for measuring its distance from the calycine end of the underlying pear and communicating it to the control unit, suitable to determine the height position of the endocarp of that pear and to control the simultaneous lowering of a coring rod and of a pitting knife from its rest position to the height of the endocarp of the underlying pear, as determined by the control unit.

3. The apparatus according to claim 2, wherein the contactless distance meters are laser measurement sensors.

4. The apparatus according to claim 3, wherein the laser measurement sensors are the ZX1-LD model of the Omron Corporation of Kyoto (Japan).

5. The apparatus according to claim 2, wherein at least one jaw wall has on its side a ratchet mechanism adapted to keep locked the jaw walls both in open position and in clamping position.

6. The apparatus according to claim 5, wherein the ratchet mechanism comprises an arm integral with the jaw wall provided with teeth in its free end, and a hook pivoted on the respective fixed wall of the housing and centering cup and loaded by a spring to engage with the teeth of the arm of the facing jaw wall so as to lock the jaw walls both in open position and in clamping position.

7. The apparatus according to claim 2, wherein the front wall and rear wall of the housing and centering cup are mutually connected with a pair of pins passing through ribbed parts of a funnel located between the front wall and rear wall and shaped according to a profile conjugated to that of a halving blade, a helical spring being abutted between a ribbed part and the facing jaw wall, so that each jaw wall is loaded towards the open position delimited by protrusions at the ends of the front and rear fixed walls.

8. The apparatus according to claim 7, wherein provided in the coring and pitting substation on a plane connected to the frame of the apparatus is, for each housing and centering cup, a pair of pneumatic pistons adapted to push on the bases of both jaw walls in a decentralized position with respect to the rotation pins to bring the jaw walls to the clamping position by acting against the helical springs.

9. The apparatus according to claim 7, wherein provided in the halving substation is a pneumatic piston adapted to act on said hook to bring each jaw wall in the open position with the help of said helical springs.

10. The apparatus according to claim 2, wherein in the coring and pitting substation, each coring rod is coaxial to a lobed shaft carrying a pitting knife, each lobed shaft being pivotably mounted by means of its own pinion bushing unit engaged, like the lobed shafts carrying the other pitting knives, with a rack driven back and forth by means of a first gearmotor.

11. The apparatus according to claim 10, wherein the coring rod slides inside a coaxial duct formed by the lobed shaft in which is provided a fixed spindle adapted to prevent the lifting of core residues inside the coaxial duct by the coring rod when the coring rod and the pitting knife are simultaneously moved upwards to the rest position.

12. The apparatus according to claim 2, wherein in the halving substation the halving blades are mounted on a horizontal rod, vertically movable on lateral guides integral with the frame of the apparatus by means of a second gearmotor to which the horizontal rod is connected with a system of levers.
